(19) United States
(12) Patent Application Publication
(10) Pub. No.: US 2021/0334701 A1
(43) Pub. Date: Oct. 28, 2021

(54) MACHINE LEARNING METHOD

(71) Applicant: Tamkang University, New Taipei City (TW)

(72) Inventors: Chih-Yung Chang, New Taipei City (TW); Shih-Jung Wu, New Taipei City (TW); Kuo-Chung Yu, New Taipei City (TW); Li-Pang Lu, New Taipei City (TW); Chia-Chun Wu, New Taipei City (TW)

(73) Assignee: Tamkang University, New Taipei City (TW)

(21) Appl. No.: 17/075,128

(22) Filed: Oct. 20, 2020

(30) Foreign Application Priority Data
Apr. 27, 2020 (TW) 109114083

(51) Int. Cl. G06N 20/00; G06K 9/62; G06K 9/00

(52) U.S. Cl. CPC G06N 20/00; G06K 9/6215; G06K 9/00288; G06K 9/6256; G06K 9/622

(57) ABSTRACT

A machine learning method is provided, including: obtaining training data, where the training data includes a training feature, training labels, and a training weight; inputting the training data to a first machine learning model, where the first machine learning model has first model data, the first model data includes a first model feature, first model labels, and first model weights, and the first model labels correspond to the first model weights in a one-to-one manner; and training the first machine learning model by using a training step to obtain a second machine learning model. The training step includes: when the first model feature matches the training feature, and one of the first model labels is the same as any of the training labels, adjusting the first model weight corresponding to the first model label that is the same as any of the training labels according to the training weight.

### CROSS-REFERENCE TO RELATED APPLICATION

This non-provisional application claims priority under 35 U.S.C. § 119(a) to Patent Application No. 109114083 in Taiwan, R.O.C. on April 27, 2020, the entire contents of which are hereby incorporated by reference.

### BACKGROUND

### Technical Field

The present invention relates to a machine learning method.

### Related Art

In recent years, due to vigorous development of machine learning applications, applications such as autonomous driving, medical image detection, or human face recognition all include machine learning technologies, and even the human face recognition is applied to life.

Although the current human face recognition technology can recognize, according to collected images, faces of a same person from different images by capturing a human face feature in the collected images, a name corresponding to the human face still cannot be obtained in such technology, that is, the current human face recognition technology needs to manually mark the human name in an early stage of data collection to know the human name corresponding to the human face. In other words, a current machine learning method for matching a human face to a human name is still in a stage of semi-automatic learning, and machine learning cannot be fully automated.

### SUMMARY

In some embodiments, a machine learning method includes: obtaining training data, where the training data includes a training feature, a plurality of training labels, and a training weight; inputting the training data to a first machine learning model, where the first machine learning model has first model data, the first model data includes a first model feature, first model labels, and first model weights, and the first model labels correspond to the first model weights in a one-to-one manner; and training the first machine learning model by using a training step to obtain a second machine learning model. The training step includes: when the first model feature matches the training feature, and one of the first model labels is the same as any of the training labels, adjusting the first model weight corresponding to the first model label that is the same as any of the training labels according to the training weight.

To sum up, in some embodiments of the present invention, the machine learning method includes: obtaining the training data, the training data including the training feature, the plurality of training labels, and the training weight; and when one of the first model labels is the same as any of the training label, adjusting the first model weight corresponding to the first model weight the same as any of the training labels according to the training weight, so that the first machine learning model may be trained to obtain the second machine learning model.

### BRIEF DESCRIPTION OF THE DRAWINGS

FIG. 1 is a flowchart of a machine learning method according to some embodiments of the present invention;

FIG. 2 is a schematic diagram of a machine learning system according to some embodiments of the present invention;

FIG. 3 is a schematic diagram of a human face image according to some embodiments of the present invention; and

FIG. 4 is a flowchart of a model executing step according to some embodiments of the present invention.

### DETAILED DESCRIPTION

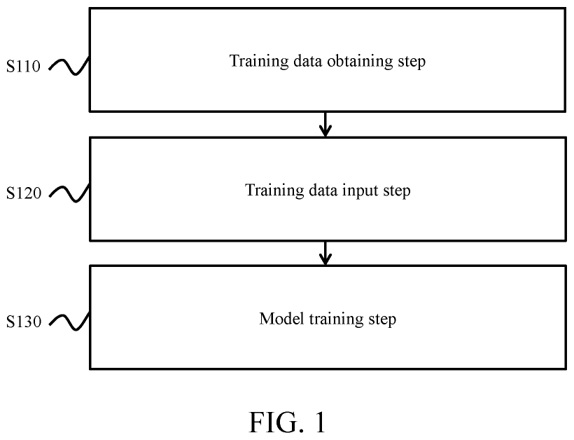

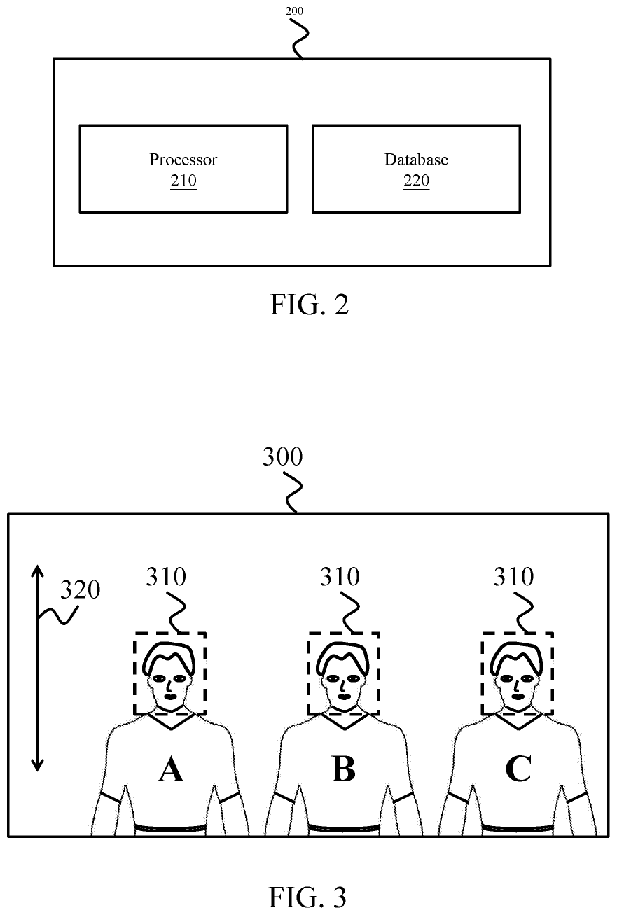

FIG. 1 is a flowchart of a machine learning method according to some embodiments of the present invention. FIG. 2 is a schematic diagram of a machine learning system 200 according to some embodiments of the present invention. Referring to both FIG. 1 and FIG. 2, in some embodiments, the machine learning system 200 includes a processor 210 and a database 220. The processor 210 is configured to train a first machine learning model according to the machine learning method, and the database 220 is configured to store the first machine learning model. The machine learning method includes the following steps: a training data obtaining step (step 110); a training data input step (step 120); and a model training step (step 130).

In some embodiments, the training data obtaining step (step S110 in FIG. 1) includes: obtaining training data, the training data including a training feature, a plurality of training labels, and a training weight. In some embodiments, the processor 210 is configured to obtain the training data. In detail, the training weight is a numerical value. For example, the training weight is a reciprocal of a total number of training labels. Therefore, a corresponding training weight may be calculated by obtaining all training labels in the training data. The training data obtaining step (step S110 in FIG. 1) is not limited to obtaining one piece of training data, and a plurality of pieces of training data may further be obtained. Each of the pieces of training data includes a training data, a plurality of training labels, and a training weight. It should be particularly noted that training features of different pieces of training data may be the same or different and similarly apply to training labels and training weights of different pieces of training data. In some embodiments, the training label is a human name, and each of the training labels is used to represent a corresponding human name. For example, the training labels are “Mr. A”, “Mr. B”, and “Mr. E”, and the training weight is “1/3”.

FIG. 3 is a schematic diagram of a human face image according to some embodiments of the present invention. Referring to FIG. 3, in some embodiments, a picture 300 includes one or more human face images 310. Each human face image 310 has a corresponding human face feature value, for example, the human face feature value is a vector matrix. In detail, each training feature corresponds to a respective human face set. The human face set includes one or more human face images 310. Therefore, the human face feature value of the human face image 310 may be used to calculate a training feature. For example, the training feature is a “128×1” dimensional vector matrix. For training features of different pieces of training data, each of the training features corresponds to a respective human face set in a one-to-one manner. In some embodiments, the training data is shown in the following

TABLE 1
Training data

| Training feature | | | Training label | Training weight |
|---|---|---|---|---|
| | 0.01 | | Mr. A | 1/3 |
| | . | | Mr. B | |
| {open oversize bracket} | . | {close oversize bracket} | Mr. E | |
| | . | | | |
| | −0.03 | | | |
| | 128x1 | | | |

The training feature is the “128×1” dimensional vector matrix. There are “3” training labels in total, which are respectively “Mr. A”, “Mr. B”, and “Mr. E”. The training weight is“⅓”. Because the training weight is a reciprocal of a total number of training labels “3”, the training weight is “⅓”.

In some embodiments, the training data input step (step 120 in FIG. 1) includes: inputting the training data to a first machine learning model, the first machine learning model having first model data, the first model data including a first model feature, a plurality of first model labels, and a plurality of first model weights, the first model labels corresponding to the first model weights in a one-to-one manner. In some embodiments, the processor 210 is configured to input the training data to the first machine learning model. In detail, for example, unsupervised learning, a support vector machine, cluster analysis, artificial neural network, or deep learning is used as a framework of the machine learning model (that is, the first machine learning model or a second machine learning model, a third machine learning model or other corresponding machine learning models in a subsequent paragraph), but is not limited thereto. In some embodiments, the database 220 is configured to store one or more machine learning models.

In some embodiments, the machine learning model is configured to receive training data or to-be-recognized data. The machine learning model has a plurality of pieces of model data, such as first model data, second model data, or other model data in the subsequent paragraph. Each of the pieces of model data includes one model feature, a plurality of model labels, and a plurality of model weights, and the model labels correspond to the model weights in a one-to-one manner. When the training data is input to the machine learning model for training, the machine learning model determines to-be-trained model data based on the training data, that is, the model feature, the model labels, and the model weights in the model data are updated. When the to-be-recognized data is input to the machine learning model, the machine learning model determines to-be-executed model data based on the to-be-recognized data, that is, determines a model weight with the highest score from the pieces of model data, and outputs a model label corresponding to the model weight with the highest score. Therefore, the machine learning model has different pieces of model data because of going through different trainings, and outputs different model labels corresponding to one piece of to-be-recognized data.

In some embodiments, the model training step (step 130 in FIG. 1) includes: training, by using a first training step, a first machine learning model to obtain a second machine learning model. In some embodiments, the processor 210 trains, by using the first training step, the first machine learning model to obtain the second machine learning model.

In some embodiments, the first training step includes: when the first model feature matches the training feature, and one of the first model labels is the same as any of the training labels, adjusting the first model weight corresponding to the first model label that is the same as any of the training labels according to the training weight. In detail, when the first model feature matches the training feature, in the first training step, the first model weight corresponding to the first model label is adjusted according to the first model label the same as the training label in the first model feature. Therefore, there may be one or more to-be-adjusted first model weights, and a method for adjusting the first model weight is, for example, using a sum of the first model weight before adjustment and a training weight as a first model weight after adjustment. In some embodiments, model data before adjustment and model data after adjustment are shown in the following Table 2:

TABLE 2

| | |
|---|---|
| Before adjustment | After adjustment |

| First model | First model | First model | First model |
|---|---|---|---|
| label | weight | label | weight |
| Mr. A | 1/2 | Mr. A | 1/2 + 1/3 = 5/6 |
| Mr. B | 1/3 | Mr. B | 1/3 + 1/3 = 2/3 |
| Mr. C | 1/4 | Mr. C | 1/4 |
| Mr. D | 1/5 | Mr. D | 1/5 |

Reference is made to FIG. 1 for training data. The first model labels before and after adjustment are “Mr. A”, “Mr. B”, “Mr. C” and “Mr. D”. Because the first model labels “Mr. A” and “Mr. B” are the same as the training label, the corresponding first model weight needs to be adjusted according to the training weight. For example, a first model weight of the first model label “Mr. A” is adjusted to “½+⅓=⅚”. Because the first model labels “Mr. C” and “Mr. D” are not the same as the training labels, first model weights of corresponding to the first model labels do not need to be adjusted.

In some embodiments, the first training step further includes: when the first model feature matches the training feature, and one of the training labels is different from each of the first model labels, adding a training label different from each of the first model labels to the first model data to become one of the first model labels, and adding a training weight to the first model data to become one of the first model weights. In detail, when the first model feature matches the training feature, in the first training step, the training label and a corresponding training weight of the training label are added based on the training label different from each of first model labels in the first model data to become an added first model label and an added first model weight. It should be particularly noted that the number of the added first model labels is equal to the number of training labels different from each of the first model labels, and the corresponding added first model weights are all equivalent to the training weights. For example, when two first model labels are added, two added corresponding first model weights are equivalent to the training weights. In some embodiments, the first model data before and after addition are shown in the following Table 3:

TABLE 3

| | |
|---|---|
| Before addition | After addition |

| First model | First model | First model | First model |
|---|---|---|---|
| label | weight | label | weight |
| Mr. A | 5/6 | Mr. A | 5/6 |
| Mr. B | 2/3 | Mr. B | 2/3 |
| Mr. C | 1/4 | Mr. C | 1/4 |
| Mr. D | 1/5 | Mr. D | 1/5 |
| | | Mr. E | 1/3 |

Reference is made to Table 1 for the training data, and reference is made to the first model data after adjustment in Table 2 for the first model data before addition. Because the training label “Mr. E” is different from each of the first model labels “Mr. A”, “Mr. B”, “Mr. C”, and “Mr. D” of the first model data before the addition, the training label “Mr. E” and a corresponding training weight “⅓” of the training label are added to the added first model data. Therefore, the added first model data includes the first model label “Mr. E” and a corresponding first model weight “⅓” of the first model label.

It should be particularly noted that Table 2 and Table 3 are only examples and are not used to limit an order of adjustment and addition of the first model data. In other words, in some embodiments, in the first training step, the first model data may further be added, and the first model data is then adjusted, or in the first training step, the first model data is simultaneously added and adjusted.

In some embodiments, the second machine learning model includes second model data. The first training step further includes: when the first model feature does not match the training feature, adding the training data to become the second model data. The second model data includes a second model feature, a plurality of second model labels, and a plurality of second model weights. The second model feature is equivalent to the training feature, the plurality of second model labels are equivalent to the training labels in a one-to-one manner, and the second model weights are all equivalent to the training weight. In detail, when the first model feature does not match the training feature, in the first training step, the training data is added to the first machine learning model to become the added second model data. Therefore, the first machine learning model that does not include the second model data may be trained as a second machine learning model including the second model data. The training feature is used as the second model feature, each of the training labels is used as a different second model label, and the training weight is used as each second model weight. Therefore, in the first training step, the second model data may be obtained by using the training data. In some embodiments, the second model data is shown in the following Table 4:

TABLE 4
Second model data

| Second model feature | | | Second model label | Second model weight |
|---|---|---|---|---|
| | 0.01 | | Mr. A | 1/3 |
| | . | | Mr. B | 1/3 |
| {open oversize bracket} | . | {close oversize bracket} | Mr. E | 1/3 |
| | . | | | |
| | −0.03 | | | |
| | 128x1 | | | |

Reference is made to FIG. 1 for training data. The second model feature is a “128×1” dimensional vector matrix. The second model labels are respectively “Mr. A”, “Mr. B”, and “Mr. E”. The second model weights are all “⅓”.

In some embodiments, the first training step further includes: determining whether the first model feature matches the training feature according to a cosine similarity clustering algorithm. In detail, a method for determining whether the first model feature matches the training feature is, for example, but not limited to, a cosine similarity clustering algorithm, a K-nearest neighbor algorithm, a fuzzy C-means clustering algorithm, or a DBSCAN clustering algorithm. For the cosine similarity clustering algorithm, for example, the cosine similarity clustering algorithm is to calculate a cosine similarity between the first model feature and the training feature. When the cosine similarity is greater than a threshold (for example, the threshold is 0.85), it is determined that the first model feature matches the training feature. When the cosine similarity is less than or equal to the threshold, it is determined that the first model feature does not meet the training feature.

In some embodiments, when the first machine learning model has a plurality of pieces of model data (assuming that the first model data belongs to one of the pieces of model data), the cosine similarity between each model feature and the training feature is calculated according to the cosine similarity clustering algorithm, a maximum value is selected from a cosine similarity greater than the threshold, and then the model data corresponding to the maximum cosine similarity is used as to-be-trained model data. When the cosine similarity is “0.95, 0.9, 0.5, 0.1” and the threshold is “0.85”, the cosine similarity greater than the threshold is “0.95, 0.9”. Therefore, model data corresponding to the maximum cosine similarity “0.95” is used as the model data that needs to be trained by the training data.

In some embodiments, when the first machine learning model has a plurality of pieces of model data (assuming that the second model data does not belong to one of the pieces of model data), the first machine learning model calculates the cosine similarity between each model feature and the training feature according to the cosine similarity clustering algorithm. When each cosine similarity is less than or equal to the threshold, it means that each piece of model data in the first machine learning model is not suitable for being trained by the training data, and therefore training data is added as second data to the first machine learning model.

It should be particularly noted that, in some embodiments, in the machine learning method, a plurality of pieces of training data may be input to the machine learning model for training. The foregoing step for training the first machine learning model to obtain a second machine learning model is only used as an example but not as a limitation thereto. For example, in the machine learning method, according to another piece of training data, by using similar training steps, the second machine learning model is trained into a third machine model, or the first machine learning model is trained into another second machine learning model. The rest can be done in a same manner, and are not described herein again.

Still referring to FIG. 3, in some embodiments, a training data obtaining step (step S110 in FIG. 1) further includes: obtaining a plurality of human face images 310;

capturing a human face feature value of each of the human face images 310; clustering the human face images 310 into a plurality of face sets according to each of the human face feature values; and obtaining the training feature according to at least one of the human face feature values, wherein the at least one of the human face feature values corresponds to one of the human face sets.

In some embodiments, a picture 300 includes one or more human face images 310, and the picture 300 has a correction axial direction 320. A processor 210 is configured to obtain the picture 300 and capture a human face image 310 from the picture 300. For example, the processor 210 obtains the picture 300 from a database 220, outside of a machine learning system 200, or other devices (not shown in the figure) in the machine learning system 200. In detail, a method for capturing the human face image 310 from the image 300 is, for example, but not limited to, a Dlib library, an OpenCV library, a combination of the Dlib library and the OpenCV library, or other methods for capturing the human face image. For example, the method for capturing the human face image by using the combination of the Dlib library and the OpenCV library includes the following. First, when the human face image 310 is rectangular, the human face image 310 in the picture 300 is detected by using the Dlib library, and four endpoint coordinates of the human face image 310 are captured. Then, through an image processing technology of the OpenCV library, the human face image 310 is captured based on the four endpoint coordinates of the human face image 310. The image processing technology of the OpenCV library includes a human face correction technology. By using the human face correction technology, positions of eyes, a nose, a mouth, a chin, and other feature points in the human face image 310 are detected, and a skew angle between the human face image 310 and the correction axial direction 320 is determined, and then the human face image 310 is rotated according to the skew angle to obtain a corrected human face image 310.

In some embodiments, the processor 210 captures a human face feature value of each human face image 310. For example, a human face feature value of a corrected human face image 310 is captured. In detail, a method for capturing the human face feature value of the human face image 310 is, for example, but not limited to, a deep learning method based on a convolutional neural network, an LBPH algorithm, or an EigenFace algorithm. For example, in the deep learning method based on the convolutional neural network, a corresponding human face feature value is output according to an input human face image 310. The human face feature value may be a high-dimensional feature vector, such as a “128×1” dimensional vector matrix. In some embodiments, a FaceNet architecture is used for the convolutional neural network.

In some embodiments, the processor 210 clusters the human face image 310 into a plurality of human face sets according to each human face feature value. In other words, according to the human face feature value of each human face image 310, different human face images 310 are clustered into a human face set. Each human face set includes, for example, but is not limited to, one or more human face images 310, and one human face image 310 may be only clustered into one human face set. In some embodiments, a method for clustering the human face image 310 into a plurality of human face sets is, for example, but not limited to, a cosine similarity clustering algorithm, a K-nearest neighbor algorithm, a fuzzy C-means clustering algorithm, or a DBSCAN clustering algorithm. For example, the human face images are clustered into a human face by using the cosine similarity clustering algorithm. In detail, in the cosine similarity clustering algorithm, a cosine similarity between human face feature values of different human face images 310, and two human face feature values whose cosine similarity is greater than a threshold (for example, the threshold is 0.85) are classified in a same cluster, that is, two human face images 310 corresponding to the two human face feature values are classified into a human face set of a same cluster. Conversely, in the cosine similarity clustering algorithm, the two human face feature values whose cosine similarity is less than or equal to the threshold are classified into different clusters, that is, the two human face images 310 corresponding to the two human face feature values are classified into two different human face sets. In a method for calculating the cosine similarity between the human face feature values of different human face images 310, for example, in a multi-dimensional vector space, each human face feature value corresponds to one vector, and a cosine similarity between two human face feature values is used to represent an angle between two vectors, and a range of the cosine similarity may be “1 to −1”. The cosine similarity of“1” means an angle between two vectors is 0 degrees, the cosine similarity of “0” means the angle between the two vectors is 90 degrees, and the cosine similarity of “−1” means the angle between the two vectors is 180 degrees. Therefore, when the threshold is “0.85”, a corresponding included angle is approximately 31.8 degrees. In other words, when the included angle is between 0 degrees and 31.8 degrees, the two human face feature values are similar, and corresponding two human face images 310 are classified in a same cluster. In other words, when the included angle is between 31.8 degrees and 180 degrees, the two human face feature values are not similar, and corresponding two human face images 310 are classified in different clusters.

In some embodiments, the processor 210 obtains a training feature according to at least one of the human face feature values, wherein the at least one of the human face feature values corresponds to one of the human face sets. In detail, the training feature corresponds to a respective human face set, and the human face set includes one or more human face images 310. Therefore, according to the human face feature value of the human face image 310, the training feature corresponding to the human face set may be obtained. It should be particularly noted that, in some embodiments, when the human face set includes only one human face image 310, the training feature of the human face set is the human face feature value of the human face image 310. In some embodiments, when the human face set includes a plurality of human face images 310, the training feature of the human face set is, for example, but not limited to, an average value, or a median value of the plurality of human face feature values corresponding to the human face images 310, or a value obtained in other calculation method.

In some embodiments, the training data obtaining step (step S110 in FIG. 1) further includes: obtaining a plurality of human names; using the human names as the training labels, the human names corresponding to the training labels in a one-to-one manner; and using a reciprocal of a total number of the training labels as a training weight.

In some embodiments, the processor 210 obtains a plurality of human names. The processor 210, for example, but not limited to, obtains a human name from the database 220, outside of the machine learning system 200, or other devices (not shown in the figure) in the machine learning system 200. In detail, an attendance list of a meeting includes a plurality of human names, and therefore the human names may be captured from the attendance list.

In some embodiments, the processor 210 uses the human names as the training labels. The human names correspond to the training labels in a one-to-one manner. In other words, the human names are used as the training labels, and each of the training labels represents one different human name.

In some embodiments, the processor 210 uses a reciprocal of a total number of the training labels as a training weight. In other words, the reciprocal of the total number of the training labels is calculated to obtain the training weight. For example, when the total number of the training labels is “5”, the reciprocal of the total number of the training labels is “⅕”, and therefore the training weight is “⅕”. In some embodiments, the number of the human names obtained by the processor 210 is equal to the number of the training labels. For example, there are a total of “5 human names” in the attendance list of the meeting, and the processor 210 obtains the “5 human names” according to the attendance list of the meeting, so that the training weight may be calculated as “⅕”.

In some embodiments, a meeting has a corresponding attendance list and a meeting photo. The attendance list includes names of persons participating in the meeting. There is one or more meeting photo, and the meeting photo includes a single photo or a group photo of the persons participating in the meeting. Therefore, in the training data obtaining step (step S110 in FIG. 1), a training label and a training weight may be obtained based on the attendance list, and a plurality of human face images 310 are obtained based on one or more meeting photos. In other words, each face image 310 is, for example, but not limited to, obtained from a same meeting photo (picture 300). Afterwards, in the training data obtaining step (step S110 in FIG. 1), the human face image 310 is clustered into a plurality of human face sets, so that a training feature corresponding to each of the human face sets may be obtained. Therefore, in the training data obtaining step (step S110 in FIG. 1), one or more pieces of training data may be obtained according to the attendance list and photos of the meeting. The number of pieces of the training data is equal to the number of the human face sets, the training feature in the training data corresponds to the human face set. Training labels between each piece of training data are the same, and the training weights between each piece of the training data are the same. The number of the human face sets may be equal to or not equal to the number of human names. It should be particularly noted that the attendance list and the photos of the meeting are only examples, and the training data obtaining step (step S110 in FIG. 1) is not limited to thereto. In some embodiments, when a plurality object names and pictures 300 with one or more object images are obtained, there is a correspondence between the object images and the object names, and in the training data obtaining step (step S110 in FIG. 1), the training data may be further obtained according to the object names and the pictures 300 with the object images.

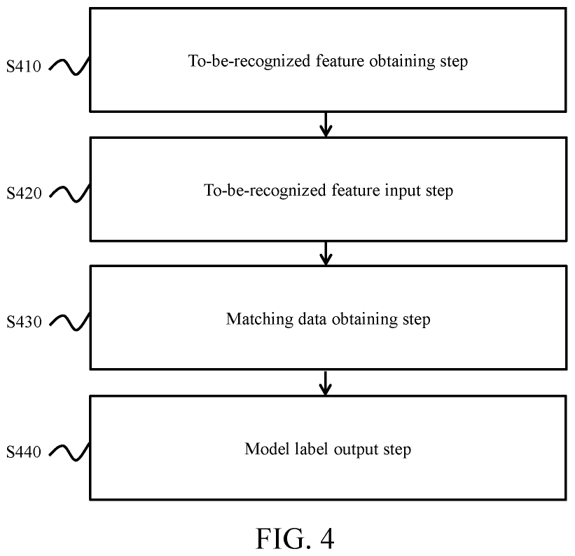

FIG. 4 is a flowchart of a model executing step according to some embodiments of the present invention. Referring to FIG. 4, in some embodiments, the machine learning method further includes a model executing step. The model executing step includes: a to-be-recognized feature obtaining step (step 410); a to-be-recognized feature input step (step 420); a matching data obtaining step (step 430); and a model label output step (step 440). In some embodiments, the processor 210 may operate a second machine learning model according to the model executing step.

In some embodiments, the to-be-recognized feature obtaining step (step 410 in FIG. 4) includes: obtaining the to-be-recognized feature. The to-be-recognized feature may be a vector matrix, for example, the to-be-recognized feature is a “128×1” dimensional vector matrix.

In some embodiments, the to-be-recognized feature obtaining step (step 410 in FIG. 4) includes: obtaining a to-be-recognized human face image; capturing a to-be-recognized human face feature value of the to-be-recognized human face image; and using the to-be-recognized human face feature value as the to-be-recognized feature. In detail, the to-be-recognized feature obtaining step (step 410 in FIG. 4) is similar to the training data obtaining step. The to-be-recognized human face image corresponds to the human face image 310, and the to-be-recognized human face feature value corresponds to the human face feature value. Therefore, when there is only one to-be-recognized human face image, the to-be-recognized human face feature value of the to-be-recognized human face image is the to-be-recognized feature. In some embodiments, when there is a plurality of to-be-recognized human face images, the to-be-recognized human face images may be clustered into a plurality of to-be-recognized human face sets according to a cosine similarity clustering algorithm, and then a to-be-recognized feature corresponding to each of the to-be-recognized human face sets is obtained.

In some embodiments, the to-be-recognized feature input step (step 420 in FIG. 4) includes: inputting the to-be-recognized feature to the second machine learning model. The second machine learning model has a plurality of pieces of model data.

In some embodiments, the matching data obtaining step (step 430 in FIG. 4) includes: selecting a piece of matching data from the pieces of model data according to the to-be-recognized feature. The matching data includes a matching feature, a plurality of model labels, and a plurality of model weights. The model labels correspond to the model weights in a one-to-one manner, and the matching feature matches the to-be-recognized feature. In detail, the piece of matching data is selected from the pieces of model data according to the to-be-recognized feature, which means that a model feature best matching the to-be-recognized feature is selected from the plurality of model features, and the model data corresponding to the model feature is used as the matching data. Each model feature respectively corresponds to respective model data.

In some embodiments, a method for selecting the piece of matching data from the pieces of model data according to the to-be-recognized feature is, for example but not limited to, a cosine similarity clustering algorithm, a K-nearest neighbor algorithm, a fuzzy C-means clustering algorithm, a DBSCAN clustering algorithm, or a combination of the foregoing methods. For example, the piece of matching data is selected from the pieces of model data according to the K-nearest neighbor algorithm. In detail, a model feature closest to the to-be-recognized feature is calculated according to the K-nearest neighbor algorithm, and the model feature closest to the to-be-recognized feature is used as the matching feature. In some embodiments, in the matching data obtaining step (step 430 in FIG. 4), it is verified, based on the cosine similarity clustering algorithm, whether the matching feature is the model feature best matching the to-be-recognized feature. In detail, based on the cosine similarity clustering algorithm, a cosine similarity between the matching feature and the to-be-recognized feature is calculated. When the cosine similarity is greater than a threshold (for example, the threshold is 0.85), the matching feature is the model feature best matching the to-be-recognized feature. In some embodiments, when the cosine similarity is less than or equal to the threshold, the matching feature is not the model feature best matching the to-be-recognized feature. In the machine learning method, according to the foregoing training data obtaining step (step 110), the training data input step (step 120), and the model training step (step 130), model data corresponding to the to-be-recognized feature is retrained for the second machine learning model.

In some embodiments, the model label output step (step 440 in FIG. 4) includes: outputting a model label corresponding to a model weight with a highest score. In detail, because the matching data includes a matching feature, a plurality of model labels, and a plurality of model weights, the model labels correspond to the model weights in a one-to-one manner. Therefore, the model weight with the highest score represents a model weight with the highest score in the matching data, and the model weight with the highest score corresponds to a model label in the matching data. It should be particularly noted that the model executing step is used to output a corresponding model label according to the to-be-recognized feature, that is, the to-be-recognized feature is input to execute a second machine learning model, and a corresponding model label is obtained by using the second machine learning model. In some embodiments, the matching data is shown in the following Table 5:

TABLE 5
Matchine data

| Model label | Model weight |
|---|---|
| Mr. A | 5/6 |
| Mr. B | 2/3 |
| Mr. C | 1/4 |
| Mr. D | 1/5 |
| Mr. E | 1/3 |

In the matching data, because the model weight with the highest score is “⅚”, a model label corresponding to the model weight with the highest score is “Mr. A”. Therefore, according to the model executing step, the second machine learning model outputs the model label “Mr. A”.

To sum up, in some embodiments of the present invention, the machine learning method includes: obtaining the training data, the training data including the training feature, the plurality of training labels, and the training weight; and when one of the first model labels is the same as any training label, adjusting the first model weight corresponding to the first model label the same as any training label according to the training weight, so that the first machine learning model is trained to obtain the second machine learning model. In some embodiments, the machine learning method further includes the model executing step. The model executing step includes: obtaining the to-be-recognized feature; selecting matching data from the pieces of model data according to the to-be-recognized feature, the matching data including the matching feature, the plurality of model labels, and the plurality of model weights, and the matching features matching the to-be-recognized feature; and then outputting the model label corresponding to the model weight with the highest score. In some embodiments, because the training data may be obtained in an automated manner without manually labelling, the first machine learning model may be trained in the automated manner through the machine learning method to obtain the second machine learning model. In some embodiments, the machine learning method is used to train a machine learning model matching a human face to a human name.

What is claimed is:

1. A machine learning method, comprising:
a training data obtaining step for obtaining training data, wherein the training data comprises a training feature, a plurality of training labels, and a training weight;
a training data input step for inputting the training data to a first machine learning model, wherein the first machine learning model has first model data, wherein the first model data comprises a first model feature, a plurality of first model labels, and a plurality of first model weights, wherein the first model labels correspond to the first model weights in a one-to-one manner; and
a model training step for training the first machine learning model by using a training step to obtain a second machine learning model; wherein
the training step comprises: when the first model feature matches the training feature, and one of the first model labels is the same as any of the training labels, adjusting the first model weight corresponding to the first model label that is the same as any of the training labels according to the training weight.

2. The machine learning method according to claim 1, wherein the training step further comprises: determining whether the first model feature matches the training feature according to a cosine similarity clustering algorithm.

3. The machine learning method according to claim 1, wherein the training step further comprises: when the first model feature matches the training feature, and one of the training labels is different from each of the first model labels, adding the training label different from each of the first model labels to the first model data to become one of the first model labels, and adding the training weight to the first model data to become one of the first model weights.

4. The machine learning method according to claim 1, wherein the second machine learning model comprises second model data, and the training step further comprises: when the first model feature does not match the training feature, adding the training data to become the second model data, the second model data comprising a second model feature, a plurality of second model labels, and a plurality of second model weights, wherein the second model feature is equivalent to the training feature, the second model labels are equivalent to the training labels in a one-to-one manner, and the second model data are all equivalent to the training weight.

5. The machine learning method according to claim 1, wherein the training data obtaining step further comprises:
obtaining a plurality of human face images;
capturing a human face feature value of each of the human face images;
clustering the human face images into a plurality of human face sets according to each of the human face feature values; and
obtaining the training feature according to at least one of the human face feature values, wherein the at least one of the human face feature values corresponds to one of the human face sets.

6. The machine learning method according to claim 5, wherein the human face images are clustered into the human face sets by using a cosine similarity clustering algorithm.

7. The machine learning method according to claim 1, wherein the training data obtaining step further comprises:
obtaining a plurality of human names;
using the human names as the training labels, the human names corresponding to the training labels in a one-to-one manner; and
using a reciprocal of a total number of the training labels as the training weight.

8. The machine learning method according to claim 1, further comprising a model executing step, wherein the model executing step comprises:
obtaining a to-be-recognized feature;
inputting the to-be-recognized feature to the second machine learning model, wherein the second machine learning model has a plurality of pieces of model data;
selecting a piece of matching data from the pieces of model data according to the to-be-recognized feature, wherein the piece of matching data comprises a matching feature, a plurality of model labels, and a plurality of model weights, wherein the model labels correspond to the model weights in a one-to-one manner, and the matching feature matches the to-be-recognized feature; and
outputting the model label corresponding to the model weight with a highest score.

9. The machine learning method according to claim 8, wherein the step of obtaining the to-be-recognized feature comprises:
obtaining a to-be-recognized human face image;
capturing a to-be-recognized human face feature value of the to-be-recognized human face image; and
using the to-be-recognized human face feature value as the to-be-recognized feature.

10. The machine learning method according to claim 8, wherein the piece of matching data is selected from the pieces of model data by using a K-nearest neighbor algorithm.
